(19) United States
(12) Patent Application Publication
(10) Pub. No.: US 2024/0031412 A1
(43) Pub. Date: Jan. 25, 2024

(54) ADDRESS MANAGEMENT APPARATUS, ADDRESS MANAGEMENT SYSTEM, ADDRESS MANAGEMENT METHOD, AND PROGRAM

(71) Applicant: NEC Corporation, Minato-ku, Tokyo (JP)

(72) Inventor: Kentaro SONODA, Tokyo (JP)

(73) Assignee: NEC Corporation, Minato-ku, Tokyo (JP)

(21) Appl. No.: 18/038,959

(22) PCT Filed: Dec. 3, 2020
(86) PCT No.: PCT/JP2020/045065

§ 371 Date: May 25, 2023

(51) Int. Cl. H04L 9/40

(52) U.S. Cl. CPC H04L 63/20; H04L 63/126

(57) ABSTRACT

In order to appropriately ensure authenticity of a security inspection execution terminal and provide an environment for executing security inspection, even when address information of the security inspection execution terminal is changed, an address management apparatus includes: an obtaining unit configured to obtain address information related to one or more security inspection execution terminals accessing a security inspection target system for security inspection; and a disclosure processing unit configured to disclose, in response to a request from a network node managing the security inspection target system, to the network node, address information related to the one or more security inspection execution terminals.

### TECHNICAL FIELD

The present invention relates to an address management apparatus, an address management system, an address management method, and a program that are for managing address information related to one or more security inspection execution terminals accessing a security inspection target system for security inspection.

### BACKGROUND ART

Services for performing security inspection of a system constituted by software, hardware, and the like are provided. For example, a company using such a service can grasp security flaws and vulnerabilities of systems owned by the company (for example, a web system performing data processing in response to access from a terminal). The company can consequently take security measures, based on information thus grasped and the like.

A kind of technique of the above-described security inspection is a penetration test. In a penetration test, an inspection target system is accessed for an investigation, intrusion, a cyberattack, and the like via the Internet, to thereby be able to check potential vulnerabilities of the inspection target system, and robustness of the inspection target system and the degree of the robustness.

Generally, before security inspection is started, the inspector (pentester) who is to perform a penetration test informs an inspection client of the Internet Protocol (IP) address of an inspection terminal and information related to the identity of the inspector himself/herself. This is to distinguish between performance of the penetration test and an actual cyberattack during the period of the inspection. In order to perform security inspection via the Internet, the following operation is needed, for example. Specifically, when a rule for refusing certain access by using a firewall or the like provided in the inspection target system is configured, it is not possible to sufficiently perform a penetration test for part of the inspection target system inside the firewall. To address this, during the period of the security inspection by a penetration test, an operation for permitting access from an inspection execution terminal may be needed.

For example, PTL 1 describes that, in order to prevent spoofing and invitations by an unintended third party, an authorization system obtains and verifies terminal information with a genuine signature, to unlock a smart lock when the terminal information is authenticated.

### CITATION LIST

### Patent Literature

[PTL 1] WO 2020/040313

### SUMMARY

### Technical Problem

In the above-described technique disclosed in PTL 1 and the like, authenticity of a terminal and a user using the terminal can be checked by using a digital signature and the like. However, in this case, when the IP address configured for the terminal is changed, verification of the digital signature and authentication using challenge-response need be performed again.

For example, in security inspection such as a penetration test, change of address information of an inspection execution terminal is assumed. For example, when security inspection is performed by using the tethering function of a smartphone, the address of a security inspection execution terminal may be changed with the lapse of time.

An example object of the present invention is to provide an address management apparatus, an address management system, an address management method, and a program with which it is possible to appropriately ensure authenticity of a security inspection execution terminal and provide an environment for executing security inspection, even when address information of the security inspection execution terminal is changed.

### Solution to Problem

According to an aspect of the present invention, an address management apparatus includes: an obtaining unit configured to obtain address information related to one or more security inspection execution terminals accessing a security inspection target system for security inspection; and a disclosure processing unit configured to disclose, in response to a request from a network node managing the security inspection target system, to the network node, address information related to the one or more security inspection execution terminals.

According to an aspect of the present invention, an address management system includes: a security inspection target system; a network node configured to manage the security inspection target system; one or more security inspection execution terminals configured to access the security inspection target system for security inspection; and an address management apparatus configured to manage address information related to the one or more security inspection execution terminals, wherein the address management apparatus includes an obtaining unit configured to obtain the address information related to the one or more security inspection execution terminals and a disclosure processing unit configured to disclose, in response to a request from the network node, to the network node, the address information related to the one or more security inspection execution terminals.

According to an aspect of the present invention, an address management method includes: obtaining address information related to one or more security inspection execution terminals accessing a security inspection target system for security inspection; and disclosing, in response to a request from a network node managing the security inspection target system, to the network node, address information related to the one or more security inspection execution terminals.

According to an aspect of the present invention, a program causes a computer to execute: obtaining address information related to one or more security inspection execution terminals accessing a security inspection target system for security inspection; and disclosing, in response to a request from a network node managing the security inspection target system, to the network node, address information related to the one or more security inspection execution terminals.

### Advantageous Effects of Invention

According to the above-described aspects, it is possible to appropriately ensure authenticity of a security inspection execution terminal and provide an environment for executing security inspection, even when address information of the security inspection execution terminal is changed. Note that, according to the present invention, instead of or together with the above effects, other effects may be exerted.

### BRIEF DESCRIPTION OF THE DRAWINGS

FIG. 1 is an explanatory diagram illustrating an example of a configuration of an address management system 1 employed in example embodiments of the present disclosure;

FIG. 2 is a block diagram illustrating an example of a configuration of an address management apparatus 100;

FIG. 3 is a diagram illustrating an example of a configuration of information elements included in pentester information 300;

FIG. 4 is a diagram illustrating an example of a configuration of pentester registration information 400 related to pentester information stored in a storage unit 120;

FIG. 5 is a diagram illustrating an example of a configuration of pentester registration information 500 including approval result as an information element;

FIG. 6 is a block diagram illustrating an example of a concrete configuration of a monitoring unit 135;

FIG. 7 is an explanatory diagram for describing a flow of processing of the entire address management system 1 when connectivity of the address information is enabled;

FIG. 8 is an explanatory diagram for describing a flow of the processing of the entire address management system 1 when connectivity of the address information is disabled;

FIG. 9 is a block diagram illustrating an example of a schematic configuration of an address management apparatus 100 according to an example alteration;

FIG. 10 is an explanatory diagram for describing a concrete example of communication permission information when a security apparatus 22 operates as a firewall;

FIG. 11 is an explanatory diagram for describing a flow of processing related to a control information transmission processing unit 141; and

FIG. 12 is a block diagram illustrating an example of a schematic configuration of an address management apparatus 100 according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of the Present Invention

2. Address Management System 1

3. First Example Embodiment
3.1. Configuration of Address Management Apparatus 100
3.2. Operation Example
3.3. Example Alterations

4. Second Example Embodiment
4.1. Configuration of Address Management Apparatus 100
4.2. Operation Example

5. Other Example Embodiments

### 1. Overview of Example Embodiments of the Present Invention

First, an overview of example embodiments of the present invention will be described.

(1) Technical Issues

Services for performing security inspection of a system constituted by software, hardware, and the like are provided. For example, a company using such a service can grasp security flaws and vulnerabilities of systems owned by the company (for example, a web system performing data processing in response to access from a terminal). The company can consequently take security measures, based on information thus grasped and the like.

A kind of technique of the above-described security inspection is a penetration test. In a penetration test, an inspection target system is accessed for an investigation, intrusion, a cyberattack, and the like via the Internet, to thereby be able to check potential vulnerabilities of the inspection target system, and robustness of the inspection target system and the degree of the robustness.

Generally, before security inspection is started, the inspector (pentester) who is to perform a penetration test informs an inspection client, of the Internet Protocol (IP) address of an inspection terminal and information related to the identity of the inspector himself/herself. This is to distinguish between performance of the penetration test and an actual cyberattack during the period of the inspection. In order to perform security inspection via the Internet, the following operation is needed, for example. Specifically, when a rule for refusing certain access by using a firewall or the like provided in the inspection target system is configured, it is not possible to sufficiently perform a penetration test for part of the inspection target system inside the firewall. To address this, during the period of the security inspection by a penetration test, an operation for permitting access from an inspection execution terminal may be needed.

For example, in order to prevent spoofing and invitations by an unintended third party, authenticity of a terminal and a user using the terminal can be checked by using a digital signature and the like. However, in this case, when the IP address configured for the terminal is changed, verification of the digital signature and authentication using challenge-response need be performed again.

For example, in security inspection such as a penetration test, change of address information of an inspection execution terminal is assumed. For example, when security inspection is performed by using the tethering function of a smartphone, the address of a security inspection execution terminal may be changed with the lapse of time.

In view of these, an example object of the present example embodiment is to appropriately ensure authenticity of a security inspection execution terminal and provide an environment for executing security inspection, even when address information of the security inspection execution terminal is changed.

(2) Technical Features

In the example embodiments of the present disclosure, address information related to one or more security inspection execution terminals accessing a security inspection target system for security inspection is obtained, and in response to a request from a network node managing the security inspection target system, address information related to the one or more security inspection execution terminals is disclosed to the network node.

In this way, it is possible, for example, to appropriately ensure authenticity of a security inspection execution terminal and provide an environment for executing security inspection, even when address information of the security inspection execution terminal is changed. Note that the above-described technical features are concrete examples of the example embodiments of the present invention, and it is apparent that the example embodiments of the present invention are not limited to the above-described technical features.

### 2. Address Management System 1

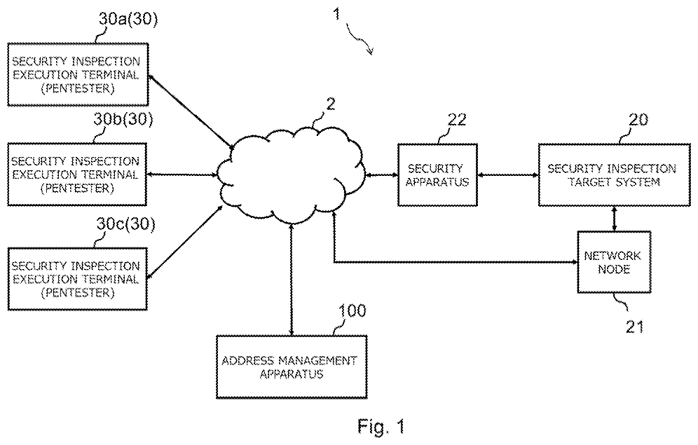

With reference to FIG. 1, an example of a configuration of an address management system 1 employed in the example embodiments of the present disclosure will be described. FIG. 1 is an explanatory diagram illustrating an example of a configuration of the address management system 1 employed in the example embodiments of the present disclosure. With reference to FIG. 1, the address management system 1 includes an address management apparatus 100, a security inspection target system 20, a network node 21, a security apparatus 22, and three security inspection execution terminals 30a, 30b, and 30c (referred to collectively as security inspection execution terminals 30). Note that the number of security inspection execution terminals 30 is not limited to the example illustrated in FIG. 1.

In the address management system 1 configured as described above, the security inspection target system 20 is an inspection target system constituted by at least one of software and hardware. More specifically, the security inspection target system 20 is, for example, a web system constituted by software resources and/or hardware resources for storing and processing data in response to access by any of the security inspection execution terminals 30, for example.

In the address management system 1, the security inspection target system 20 is accessed for an investigation, intrusion, a cyberattack, and the like. Such access is made by the security inspection execution terminal 30 via Internet 2. The address management apparatus 100 is configured to manage address information related to the security inspection execution terminal 30 as will be described below concretely.

The network node 21 is a node configured to manage the security inspection target system 20 according to an operation input by the inspection client or the like.

The security apparatus 22 functions as a firewall for preventing access such as a cyberattack, to the security inspection target system 20. The security apparatus 22 is, for example, an apparatus having a security function or a general-purpose computer implementing software having a security function. For example, the security apparatus 22 may be an intrusion prevention system/intrusion detection system (IPS/IDS), a web application firewall (WAF), or a unified threat management (UTM).

### 3. First Example Embodiment

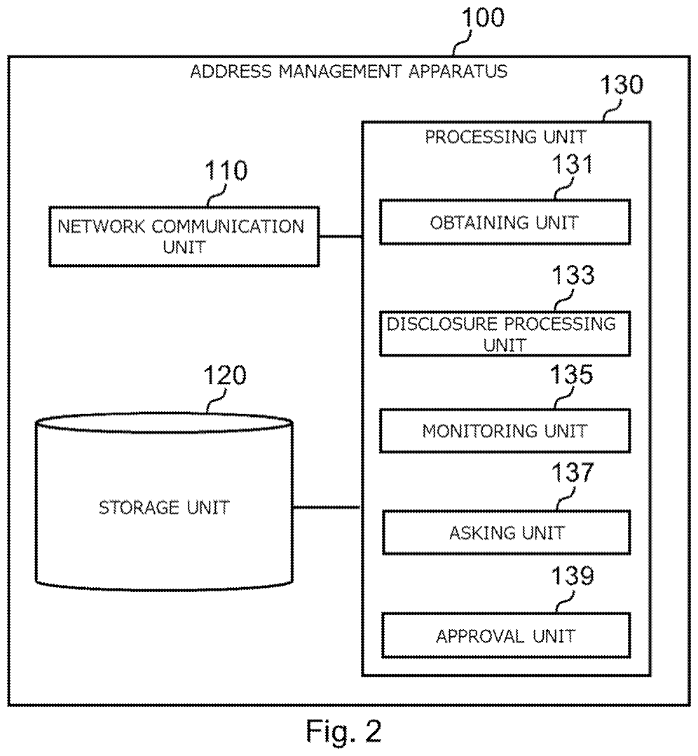

Next, with reference to FIGS. 2 to 11, a first example embodiment will be described.

<3.1. Configuration of Address Management Apparatus 100>

With reference to FIG. 2, an example of a configuration of the address management apparatus 100 according to the first example embodiment will be described. FIG. 2 is a block diagram illustrating the example of the configuration of the address management apparatus 100. With reference to FIG. 2, the address management apparatus 100 includes a network communication unit 110, a storage unit 120, and a processing unit 130.

(1) Network Communication Unit 110

The network communication unit 110 receives a signal from a network and transmits a signal to the network.

(2) Storage Unit 120

The storage unit 120 temporarily or permanently stores a program (instructions) and parameters for operations of the address management apparatus 100 as well as various data. The program includes one or more instructions for the operations of the address management apparatus 100.

(3) Processing Unit 130

The processing unit 130 provides various functions of the address management apparatus 100. The processing unit 130 includes an obtaining unit 131, a disclosure processing unit 133, a monitoring unit 135, an asking unit 137, and an approval unit 139. Note that the processing unit 130 may further include constituent elements other than these constituent elements. In other words, the processing unit 130 may also perform operations other than the operations of these constituent elements. Concrete operations of the obtaining unit 131, the disclosure processing unit 133, the monitoring unit 135, the asking unit 137, and the approval unit 139 will be described below in detail.

(4) Implementation Example

The network communication unit 110 may be implemented with a network adapter and/or a network interface card, and the like. The storage unit 120 may be implemented with a memory (e.g., a nonvolatile memory and/or a volatile memory) and/or a hard disk, and the like. The processing unit 130 may be implemented with one or more processors. The obtaining unit 131, the disclosure processing unit 133, the monitoring unit 135, the asking unit 137, and the approval unit 139 may be implemented with the same processor or may be implemented with separate processors. The memory (storage unit 120) may be included in the one or more processors or may be provided outside the one or more processors.

The address management apparatus 100 may include a memory configured to store a program (instructions) and one or more processors that can execute the program (instructions). The one or more processors may execute the program to thereby perform operations of the processing unit 130 (operations of the obtaining unit 131, the disclosure processing unit 133, the monitoring unit 135, the asking unit 137, and/or the approval unit 139). The program may be a program for causing the processor(s) to execute operations of the processing unit 130 (operations of the obtaining unit 131, the disclosure processing unit 133, the monitoring unit 135, the asking unit 137, and/or the approval unit 139).

<3.2. Operation Example>

Next, an operation example of the first example embodiment will be described.

According to the first example embodiment, the address management apparatus 100 (obtaining unit 131) obtains address information related to the security inspection execution terminal 30 accessing the security inspection target system 20 for security inspection. The address management apparatus 100 (disclosure processing unit 133) discloses, in response to a request from the network node 21, the address information related to the security inspection execution terminal 30 to the network node 21.

Here, concretely, the address information related to the security inspection execution terminal 30 corresponds to an Internet Protocol (IP) address used by the security inspection execution terminal 30 to access the Internet, a Media Access Control (MAC) address for identifying a network interface, and the like.

According to the first example embodiment, since the address information, such as the IP address, of the corresponding security inspection execution terminal 30 is disclosed to the network node 21 in response to the request from the network node 21, it is possible to appropriately ensure authenticity of the security inspection execution terminal 30 and provide an environment for executing security inspection, even when address information of the security inspection execution terminal 30 is changed.

(1) Obtaining and Management of Address Information

The address information is transmitted, for example, from the security inspection execution terminal 30 to the address management apparatus 100, as an information element in pentester information related to a pentester being the user of the security inspection execution terminal 30.

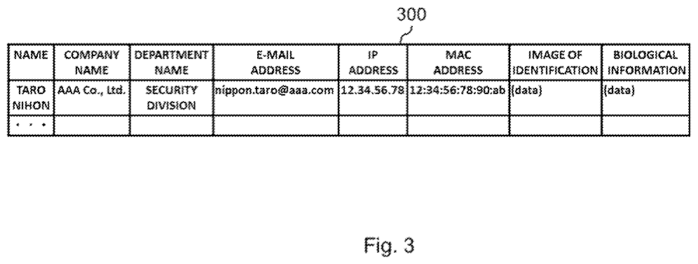

Concretely, the pentester information includes a plurality of information elements as those below. FIG. 3 is a diagram illustrating an example of a configuration of information elements included in pentester information 300. With reference to FIG. 3, the pentester information 300 includes a name, a company name, a department name, an e-mail address, an IP address, a MAC address, an image of identification (face photo included in a business card, driving or other license, or personal identification number card, or the like), and biological information (face feature quantity data, fingerprint data, iris data, or the like).

The address management apparatus 100 (obtaining unit 131) stores the pentester information obtained from the security inspection execution terminal 30, in the storage unit 120 to thereby register the pentester information.

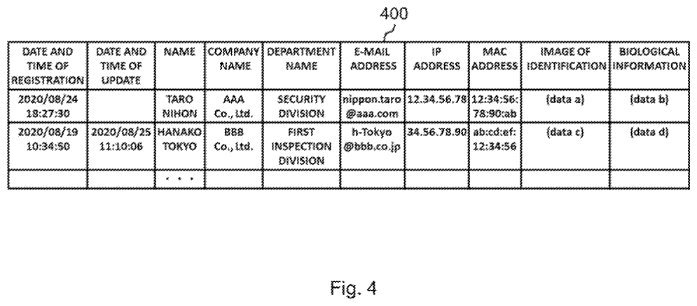

FIG. 4 is a diagram illustrating an example of a configuration of pentester registration information 400 related to the pentester information stored in the storage unit 120. With reference to FIG. 4, the pentester registration information 400 includes the pentester information 300, date and time for registration of the pentester information 300, and date and time for update of the address information (for example, the IP address and the MAC address) included in the pentester information 300. The update of the address information will be described below.

When the pentester registration information 400 is stored in the storage unit 120, the address management apparatus 100 (obtaining unit 131) may generate code information (two-dimensional code information indicating a URL) for accessing a web page displaying, in a web browser, the pentester information (for example, the pentester information 300 illustrated in FIG. 3) included in the pentester registration information 400. In other words, the code information corresponds to identification information for identifying the address information of the corresponding security inspection execution terminal 30.

(2) Disclosure of Information

The address management apparatus 100 (disclosure processing unit 133) refers to the pentester registration information 400 stored in the storage unit 120 and discloses various kinds of information related to the pentester (for example, the pentester information 300 illustrated in FIG. 3) to the inspection client side (network node 21). A method for the disclosure may be any mechanism such as a web page in a website.

As a concrete disclosure method, for example, when the code information for accessing the web page displaying the pentester information 300 in the web browser is generated as described above, the pentester information 300 is disclosed in a web page associated with the code information.

The inspection client is notified of the above-described code information as follows, for example. First, the corresponding security inspection execution terminal 30 is notified of the code information generated by the address management apparatus 100 (obtaining unit 131), by an e-mail or the like by using an e-mail address of the security inspection execution terminal 30. In this way, the pentester can receive the code information. Subsequently, the security inspection execution terminal 30 notifies, according to an operation by the pentester, the network node 21 of the code information corresponding to identification information for identifying the corresponding address information. In this way, the inspection client can receive the code information.

When the inspection client receives the code information as described above, the network node 21 accesses, according to an operation by the inspection client, a certain web page by using the code information to display the pentester information 300 of the corresponding security inspection execution terminal 30. In other words, the network node 21 makes a request using the identification information corresponding to the code information to thereby obtain address information disclosed by the disclosure processing unit 133 included in the address management apparatus 100.

(3) Approval of Address Information

The address management apparatus 100 (approval unit 139) approves, based on the notification information from the network node 21, access for the security inspection by the corresponding security inspection execution terminal 30.

Concretely, processing related to approval is performed in the following flow. First, when the address information disclosed by the above-described disclosure processing unit 133 is displayed by the network node 21, the network node 21 notifies, according to an operation by the inspection client, the address management apparatus 100 of notification information for approving security inspection by the corresponding security inspection execution terminal 30. This notification information includes an information element indicating approved or denied.

The network node 21 notifies the address management apparatus 100 of the notification information by an e-mail, for example. The disclosure processing unit 133 may generate the code information for approval notification, and in this case, by the network node 21 accessing a web page according to the code information, approval for the corresponding security inspection execution terminal 30 may be performed.

When the address management apparatus 100 (approval unit 139) receives the notification information from the network node 21, the address management apparatus 100 registers the information elements in the notification information as information elements in the pentester registration information 400 stored in the storage unit 120.

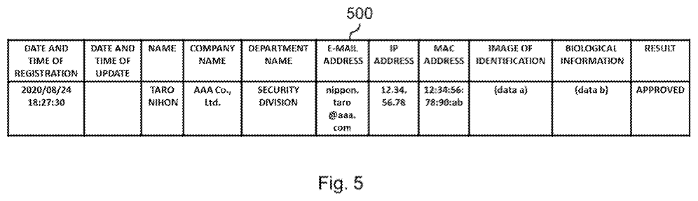

FIG. 5 is a diagram illustrating an example of a configuration of pentester registration information 500 including approval result as an information element. With reference to FIG. 5, according to the notification information, it is recognized whether access for the security inspection by the corresponding security inspection execution terminal 30 is approved or denied.

When the above-described notification information indicates denial, the address management apparatus 100 (approval unit 139) transmits information indicating that an approval result indicates denial, to the security inspection execution terminal 30 (pentester) by an e-mail. The code information for accessing a web page displaying the approval result may be transmitted to the security inspection execution terminal 30 (pentester) without being limited to the above-described transmission method.

Note that the processing related to the approval by the address management apparatus 100 (approval unit 139) is not limited to the above-described processing, and various modifications can be made thereto. For example, the approval need not be limited to that based on the notification information from the network node 21 and may be based on history information related to the security inspection execution terminal 30, for example. In this case, for example, when the number of times and/or the frequency at which the security inspection execution terminal 30 has been approved access, for security inspection, to an inspection target system other than the security inspection target system 20 in the past and the like satisfies a certain condition, access for security inspection by the corresponding security inspection execution terminal 30 may be approved without being based on the notification information from the network node 21.

(4) Monitoring and Asking for Update of Address Information

For example, when the access for the security inspection by the corresponding security inspection execution terminal 30 is approved by the approval unit 139, the address management apparatus 100 (monitoring unit 135) monitors connectivity of the address information related to the corresponding security inspection execution terminal 30. The address management apparatus 100 (asking unit 137) then transmits, based on the connectivity of the address information, information for asking for update of address information to the security inspection execution terminal 30.

—Monitoring Processing

For example, a monitoring means 150 uses, for example, a ping command to regularly check connectivity for an IP address included in the pentester registration information stored in the storage unit 120.

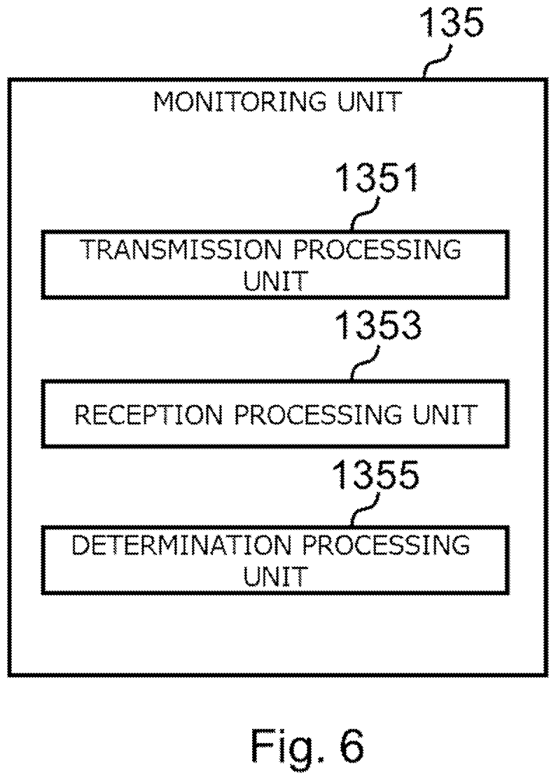

FIG. 6 is a block diagram illustrating an example of a concrete configuration of the monitoring unit 135. With reference to FIG. 6, the monitoring unit 135 includes a transmission processing unit 1351, a reception processing unit 1353, and a determination processing unit 1355.

The transmission processing unit 1351 transmits an echo request message for monitoring connectivity of address information (IP address), to the security inspection execution terminal 30 corresponding to the address information. When the connectivity of the address information is enabled, the reception processing unit 1353 receives an echo response message for the echo request message from the corresponding security inspection execution terminal 30. On the other hand, when the connectivity of the address information is disabled, the reception processing unit 1353 does not receive an echo response message for the echo request message from the corresponding security inspection execution terminal 30.

The determination processing unit 1355 determines, based on a reception state related to the echo request message, whether the connectivity of the address information related to the corresponding security inspection execution terminal 30 is enabled or disabled. For example, when the determination processing unit 1355 receives an echo request message within a certain time period, the determination processing unit 1355 determines that the connectivity of the address information related to the corresponding security inspection execution terminal 30 is enabled. On the other hand, when the determination processing unit 1355 fails to receive an echo request message within the certain time period, the determination processing unit 1355 determines that the connectivity of the address information related to the corresponding security inspection execution terminal 30 is disabled.

Monitoring of connectivity based on a ping command as described above is performed every one hour, for example. Such intervals of monitoring are not limited to one hour but may be any time period according to a request from the inspection client of the security inspection target system 20. The intervals are not limited to such predetermined intervals, and the intervals of the monitoring may be changed to any intervals.

As an example, the monitoring unit 135 configures, based on update history of the address information related to the corresponding security inspection execution terminal 30, the frequency of transmission of an echo request message to the corresponding security inspection execution terminal 30. Concretely, when the frequency of update of the address information related to the security inspection execution terminal 30 is low, this leads to an assumption that the possibility of future update is also low, and the intervals at which an echo request message is transmitted to the corresponding security inspection execution terminal 30 are configured to be longer. In contrast, when the frequency of update of the address information related to the security inspection execution terminal 30 is high, this leads to an assumption that the possibility of future update is also high, and the intervals at which an echo request message is transmitted to the corresponding security inspection execution terminal 30 are configured to be shorter.

The monitoring unit 135 may configure, based on whether the address information related to the corresponding security inspection execution terminal 30 is address information managed by a gateway server of a mobile communication provider, the frequency of transmission of an echo request message to the corresponding security inspection execution terminal 30. For example, when the address information related to the corresponding security inspection execution terminal 30 is address information managed by a gateway server of a mobile communication provider, the intervals at which an echo request message to the corresponding security inspection execution terminal 30 is transmitted are configured to be shorter than those for other cases.

When there is a response to the ping command, the address management apparatus 100 (monitoring unit 135) completes this processing. Subsequently, the address management apparatus 100 (monitoring unit 135) repeats execution of the ping command again one hour below.

In contrast, when there is no response to the ping command, the address management apparatus 100 (monitoring unit 135) determines that the IP address used by the corresponding security inspection execution terminal 30 (pentester) has been changed. In this case, the address management apparatus 100 (monitoring unit 135) notifies the asking unit 137 of information indicating that the IP address has been changed.

Note that monitoring of the address information is not limited to monitoring using a ping command. For example, agent software that can perform processing for synchronization with the address management apparatus 100 may be installed in the security inspection execution terminal 30 in advance. In this case, the agent software may then operate to poll information related to connectivity possible to be monitored by using a ping command, in the address management apparatus 100.

—Processing for Asking for Update of Address Information

When connectivity of the address information (IP address) related to the corresponding security inspection execution terminal 30 is disabled, in other words, when the IP address has been changed, the address management apparatus 100 (asking unit 137) transmits update asking information for asking for update of the address information, to the corresponding security inspection execution terminal 30.

For example, the update asking information is included in a notification mail addressed to the e-mail address included in the pentester information registered for the corresponding security inspection execution terminal 30. In this case, the security inspection execution terminal 30 (pentester) accesses, according to the notification mail, the address management apparatus 100 to request update of the IP address. In other words, based on the update asking information, the security inspection execution terminal 30 (pentester) transmits information for requesting update of the address information to the address management apparatus 100.

Note that the security inspection execution terminal 30 may further transmit, as a reply to the notification mail, information indicating inspection continuation or inspection termination to the address management apparatus 100. The notification mail may include code information for accessing a web page for updating IP addresses managed by the address management apparatus 100. In this case, the security inspection execution terminal 30 may access, according to the code information, the web page to request the address management apparatus 100 to update the IP address.

The address management apparatus 100 (obtaining unit 131) updates, according to the information for requesting the update of the IP address from the security inspection execution terminal 30, the address information related to the corresponding security inspection execution terminal (for example, the IP address, the MAC address, and the like). Concretely, the address management apparatus 100 (obtaining unit 131) updates the date and time of update, IP address, MAC address, and the like among the information elements included in the pentester registration information stored in the storage unit 120.

(5) Monitoring and Disclosure Related to Image Information

The address management apparatus 100 (monitoring unit 135) may further monitor image information related to the security inspection performed by the security inspection execution terminal 30. In this case, the address management apparatus 100 (disclosure processing unit 133) discloses, in response to a request from the network node 21, image information related to the security inspection to the network node 21.

Concretely, the address management apparatus 100 (monitoring unit 135) receives, from the security inspection execution terminal 30, data of a face image of the pentester captured by a web camera installed in the security inspection execution terminal 30 and a display monitor image, for example, and stores the received image data in the storage unit 120.

The address management apparatus 100 (disclosure processing unit 133) discloses the image data stored in the storage unit 120 to a website in response to the request from the network node 21.

In this way, the inspection client can check, by accessing the address management apparatus 100 by using the network node 21, image related to security inspection by a pentester.

(6) Flow of Processing

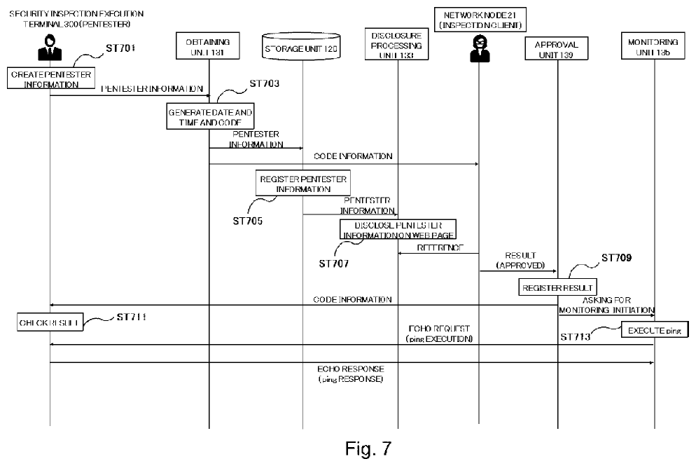

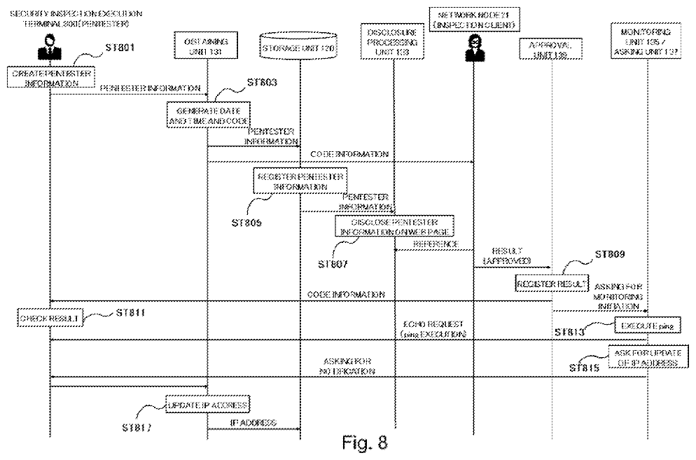

Next, with reference to FIGS. 7 and 8, a flow of processing of the entire address management system 1 according to the first example embodiment will be described. FIG. 7 is an explanatory diagram for describing a flow of the processing of the entire address management system 1 when connectivity of address information is enabled.

With reference to FIG. 7, in step ST701, the security inspection execution terminal 30 creates pentester information and transmits the created pentester information to the address management apparatus 100 (obtaining unit 131).

Then, in step ST703, based on the pentester information obtained from the security inspection execution terminal 30, the address management apparatus 100 (obtaining unit 131) creates corresponding registration date and time information and code information (code information for accessing the pentester information). The pentester information and the registration date and time information are transmitted to the storage unit 120. The code information is disclosed to the network node 21 (inspection client) by the disclosure processing unit 133.

Next, in step ST705, the address management apparatus 100 (storage unit 120) stores the pentester registration information. The pentester information included in the pentester registration information is transferred to the disclosure processing unit 133.

Then, in step ST707, the address management apparatus 100 (disclosure processing unit 133) discloses the pentester information to the web page indicated in the code information. The network node 21 (inspection client) refers, by accessing the web page by using the code information, to the pentester information. Further, the network node 21 (inspection client) transmits approval notification information related to access for security inspection using the pentester information 300 of the corresponding security inspection execution terminal 30, to the address management apparatus 100 (approval unit 139).

Then, in step ST709, the address management apparatus 100 (approval unit 139) registers the approval notification information received from the network node 21. Concretely, the address management apparatus 100 (approval unit 139) stores information indicating approval or denial as an information element included in corresponding pentester registration information, in the storage unit 120. Thereafter, the address management apparatus 100 (approval unit 139) transmits the code information for accessing a web page displaying an approval result to the corresponding security inspection execution terminal 30. The address management apparatus 100 (approval unit 139) asks the monitoring unit 135 to monitor the corresponding security inspection execution terminal 30.

Then, in step ST711, the security inspection execution terminal 30 uses the code information transmitted from the address management apparatus 100 to display the approval result. In this way, the pentester can check the approval result.

Then, in step ST713, the address management apparatus 100 (monitoring unit 135) executes a ping command to monitor connectivity of the address information of the security inspection execution terminal 30 being a monitoring target. Concretely, the address management apparatus 100 (monitoring unit 135) transmits an echo request message to the security inspection execution terminal 30 and receives an echo response message from the security inspection execution terminal 30. In this way, the address management apparatus 100 can detect that connectivity of the address information of the security inspection execution terminal 30 is enabled.

FIG. 8 is an explanatory diagram for describing a flow of the processing of the entire address management system 1 when connectivity of address information is disabled.

In the flow illustrated in FIG. 8, description of processing in steps ST801 to ST811, which is similar to the processing in steps ST701 to S712 illustrated in FIG. 7 described above, is omitted.

Then, in step ST813, the address management apparatus 100 (monitoring unit 135) executes a ping command to monitor connectivity of the address information of the security inspection execution terminal 30 being a monitoring target. Concretely, the address management apparatus 100 (monitoring unit 135) transmits an echo request message to the security inspection execution terminal 30. Here, in the example illustrated in FIG. 8, different from the example illustrated in FIG. 7, no echo response message for the echo request message is transmitted from the security inspection execution terminal 30, and hence, the monitoring unit 135 determines that connectivity of the address information is disabled.

Then, in step ST815, the address management apparatus 100 (asking unit 137) transmits update asking information for asking for update of the address information (IP address) to the security inspection execution terminal 30. In the example illustrated in FIG. 8, in response to the update asking information, information for requesting update of the address information is transmitted from the security inspection execution terminal 30 to the address management apparatus 100.

Then, in step ST817, the address management apparatus 100 (obtaining unit 131) updates, according to the information for requesting the update of the IP address from the security inspection execution terminal 30, the address information related to the corresponding security inspection execution terminal (the IP address, the MAC address, and the like). Concretely, the date and time of update, IP address, MAC address, and the like among the information elements included in the pentester registration information stored in the storage unit 120 are updated.

(7) Summary

As described above, according to the first example embodiment, the address management apparatus 100 can refer, by storing pentester information in the storage unit 120, to attribute information of the corresponding pentester and the address information (IP address) of the security inspection execution terminal 30 used by the pentester, for the inspection client.

The address management apparatus 100 (monitoring unit 135) can guarantee, by regularly or irregularly monitoring connectivity of the address information (IP address) of the security inspection execution terminal 30, that no change has been made to registration contents (pentester registration information) in the storage unit 120. Here, when connectivity of the address information is disabled, concretely when a change of the IP address has been made, the address management apparatus 100 (asking unit 137) can urge, by transmitting update asking information to the security inspection execution terminal 30, the pentester to update the registration information. In this way, for example, even when the IP address of the security inspection execution terminal 30 has been changed in execution of a penetration test, the network node 21 (inspection client) can easily check authenticity of the pentester who operates the security inspection execution terminal 30.

<3.3. Example Alteration>

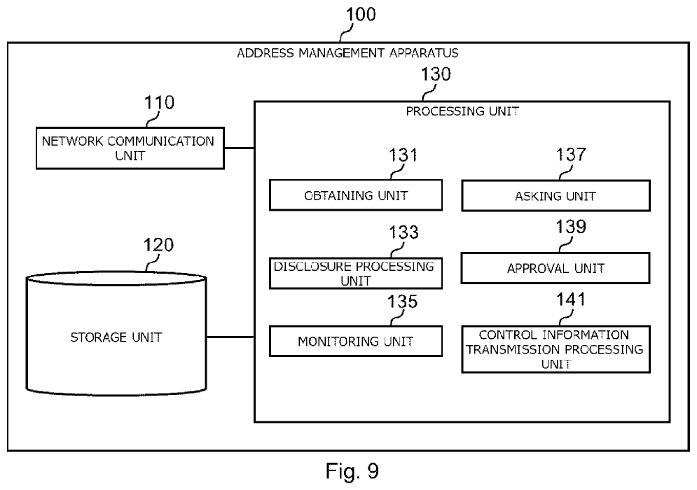

Next, the first example embodiment according to an example alteration will be described. FIG. 9 is a block diagram illustrating an example of a schematic configuration of an address management apparatus 100 according to an example alteration. With reference to FIG. 9, the address management apparatus 100 may further include a control information transmission processing unit 141 configured to transmit control information for access for the security inspection, to a network node (security apparatus 22) controlling access to the security inspection target system 20. In the following, processing related to the control information transmission processing unit 141 will be described.

Concretely, when the access for the security inspection by the security inspection execution terminal 30 is approved by the approval unit 139, the control information transmission processing unit 141 generates communication permission information for the IP address and the MAC address being corresponding address information, as control information. This communication permission information is transmitted from the control information transmission processing unit 141 to the security apparatus 22.

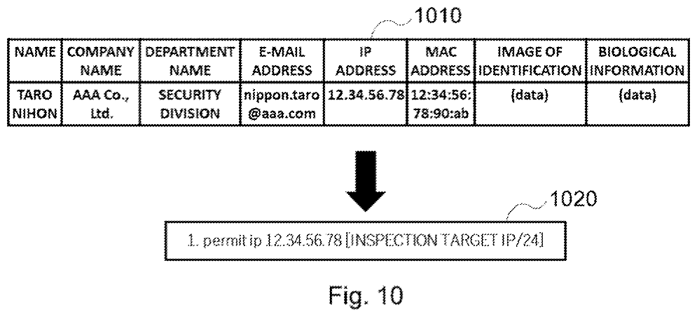

FIG. 10 is an explanatory diagram for describing a concrete example of the communication permission information when the security apparatus 22 operates as a firewall. With reference to FIG. 10, the control information transmission processing unit 141 refers to the pentester registration information 400 stored in the storage unit 120 and generates an access control list 1020 for the corresponding security inspection execution terminal 30 as the communication permission information. For example, the access control list 1020 in the example illustrated in FIG. 10 indicates that a packet with a transmission source IP address of 12.34.56.78 and a destination IP address of [INSPECTION TARGET IP/24] is permitted.

When update of the IP address is approved through the processing by the monitoring unit 135 and the asking unit 137, the control information transmission processing unit 141 waits until the registration of the update of the IP address in the pentester information is completed. Thereafter, in response to the completion of the update registration, the control information transmission processing unit 141 generates an access control list again and transmits the access control list to the security apparatus 22. Note that information for asking for approval of generation of an access control list may be transmitted to the network node 21. In this case, when the address management apparatus 100 receives, as a result of approval by the inspection client, information for requesting approval of generation of an access control list from the network node 21, the control information transmission processing unit 141 creates a new access control list.

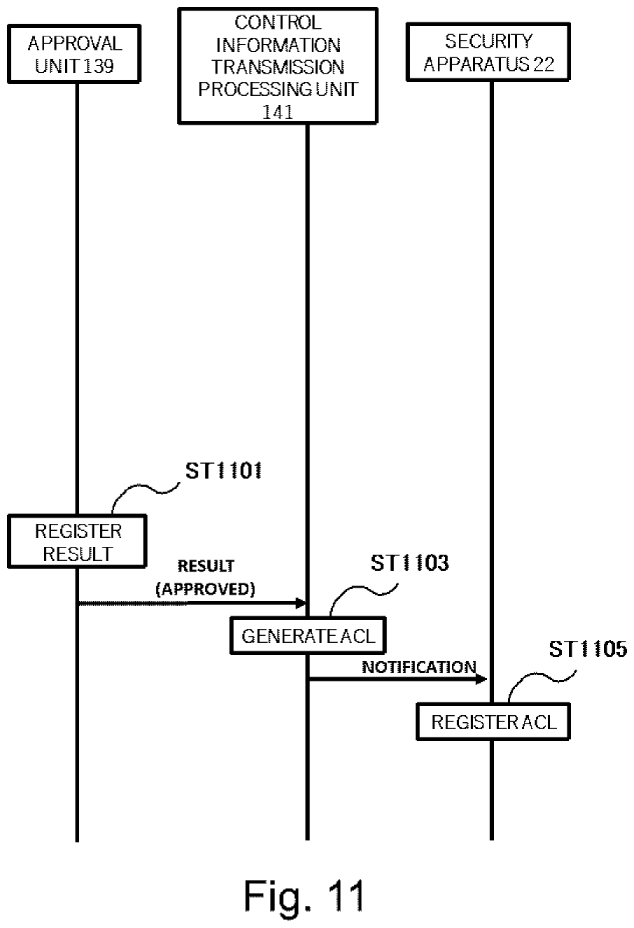

FIG. 11 is an explanatory diagram for describing a flow of processing related to the control information transmission processing unit 141. With reference to FIG. 11, first, in step ST1101, the address management apparatus 100 (approval unit 139) registers the approval notification information received from the network node 21. Thereafter, the address management apparatus 100 (approval unit 139) transmits information indicating an approval result to the control information transmission processing unit 141. Then, in step S1103, the address management apparatus 100 (control information transmission processing unit 141) generates an access control list for the security inspection execution terminal 30 being approved. The security apparatus 22 is notified of the generated access control list. Then, in step ST1105, the security apparatus 22 registers the access control list and performs access control, based on the access control list. Thereafter, the processing illustrated in FIG. 11 is terminated.

According to the processing illustrated in FIG. 11 described above, the address management apparatus 100 (control information transmission processing unit 141) can dynamically generate, according to an approval result from the approval unit 139, an access control list to be used by the security apparatus 22 operating as a firewall and the like. In this way, the address management apparatus 100 can automatically register the access control list in the security apparatus 22 without depending on an operation input or the like by the inspection client or an operator.

In other words, according to the example alteration, at the time of security inspection by a penetration tester (security inspection execution terminal 30), it is not necessary to indicate, to an operator, operation of registering a rule for permitting passing through a firewall for the inspection, for example. In this way, according to the example alteration, it is possible to provide, by reducing workload of the operator and the like, an environment for performing a penetration test more efficiently.

### 4. Second Example Embodiment

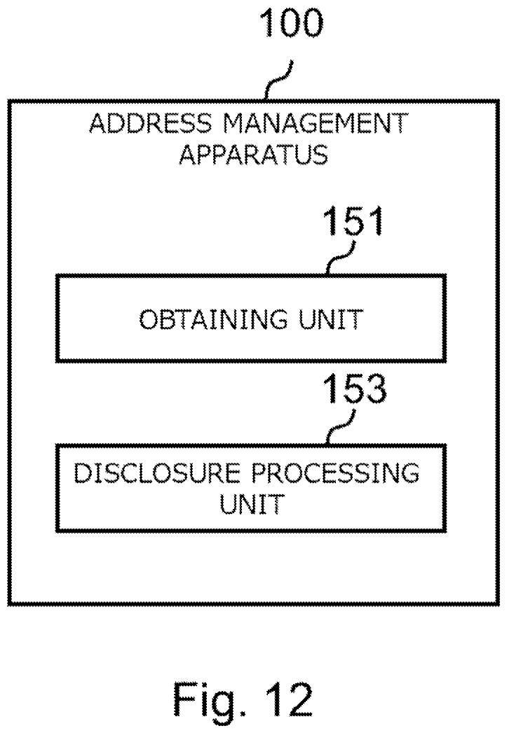

Next, a description will be given of a second example embodiment of the present invention with reference to FIG. 12. The above-described first example embodiment is a concrete example embodiment, whereas the second example embodiment is a more generalized example embodiment.

<4.1. Configuration of Address Management Apparatus 100>

FIG. 12 is a block diagram illustrating an example of a schematic configuration of an address management apparatus 100 according to the second example embodiment. With reference to FIG. 12, the address management apparatus 100 includes an obtaining unit 151 and a disclosure processing unit 153.

The obtaining unit 151 and the disclosure processing unit 153 may be implemented with one or more processors, a memory (e.g., a nonvolatile memory and/or a volatile memory), and/or a hard disk. The obtaining unit 151 and the disclosure processing unit 153 may be implemented with the same processor or may be implemented with separate processors. The memory may be included in the one or more processors or may be provided outside the one or more processors.

<4.2. Operation Example>

An operation example of the second example embodiment will be described.

According to the second example embodiment, the address management apparatus 100 (obtaining unit 151) obtains address information related to one or more security inspection execution terminals (for example, the security inspection execution terminal 30) accessing the security inspection target system (for example, the security inspection target system 20) for security inspection. The address management apparatus 100 (disclosure processing unit 153) discloses, in response to a request from the network node (for example, the network node 21) managing the security inspection target system (for example, the security inspection target system 20), the address information related to the one or more security inspection execution terminals (for example, the security inspection execution terminal 30) to the network node (for example, the network node 21).

—Relationship with First Example Embodiment

As an example, the obtaining unit 151 and the disclosure processing unit 153 included in the address management apparatus 100 according to the second example embodiment may respectively perform operations of the obtaining unit 131 and the disclosure processing unit 153 included in the address management apparatus 100 according to the first example embodiment. In this case, the descriptions of the first example embodiment may also be applicable to the second example embodiment. Note that the second example embodiment is not limited to this example.

The second example embodiment has been described above. According to the second example embodiment, it is possible to appropriately ensure authenticity of a security inspection execution terminal and provide an environment for executing security inspection, even when address information of the security inspection execution terminal is changed.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the obtaining unit and/or the disclosure processing unit) of the address management apparatus described in the Specification (e.g., one or more apparatuses (or units) among a plurality of apparatuses (or units) constituting the address management apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

An address management apparatus comprising:
an obtaining unit configured to obtain address information related to one or more security inspection execution terminals accessing a security inspection target system for security inspection; and
a disclosure processing unit configured to disclose, in response to a request from a network node managing the security inspection target system, to the network node, address information related to the one or more security inspection execution terminals.

### (Supplementary Note 2)

The address management apparatus according to supplementary note 1, further comprising:
a monitoring unit configured to monitor connectivity of the address information; and
an asking unit configured to transmit, based on the connectivity of the address information, information for asking the one or more security inspection execution terminals to update address information.

### (Supplementary Note 3)

The address management apparatus according to supplementary note 2, wherein the monitoring unit includes
a transmission processing unit configured to transmit an echo request message for monitoring the connectivity of the address information, to a corresponding security inspection execution terminal among the one or more security inspection execution terminals,
a reception processing unit configured to receive an echo response message for the echo request message, from the corresponding security inspection execution terminal, and
a determination processing unit configured to determine, based on a reception state related to the echo request message, whether the connectivity of the address information related to the corresponding security inspection execution terminal is enabled or disabled.

### (Supplementary Note 4)

The address management apparatus according to supplementary note 3, wherein the monitoring unit is configured to configure, based on update history of the address information related to the corresponding security inspection execution terminal, a frequency of transmission of the echo request message to the corresponding security inspection execution terminal.

### (Supplementary Note 5)

The address management apparatus according to supplementary note 3 or 4, wherein the asking unit is configured to transmit, when the connectivity of the address information related to
the corresponding security inspection execution terminal is disabled, information for asking for update of address information, to the corresponding security inspection execution terminal.

### (Supplementary Note 6)

The address management apparatus according to any one of supplementary notes 2 to 5, wherein
the monitoring unit is configured to further monitor image information related to security inspection performed by the one or more security inspection execution terminals, and
the disclosure processing unit is configured to disclose, in response to the request from the network node, the image information related to the security inspection to the network node.

### (Supplementary Note 7)

The address management apparatus according to any one of supplementary notes 1 to 6, further comprising
an approval unit configured to approve, based on notification information from the network node, access for the security inspection by a corresponding security inspection execution terminal among the one or more security inspection execution terminals.

### (Supplementary Note 8)

The address management apparatus according to supplementary note 7, further comprising
a control information transmission processing unit configured to transmit control information for the access for the security inspection by the corresponding security inspection execution terminal, to a network node controlling access to the security inspection target system.

### (Supplementary Note 9)

An address management system comprising:
a security inspection target system;
a network node configured to manage the security inspection target system;
one or more security inspection execution terminals configured to access the security inspection target system for security inspection; and
an address management apparatus configured to manage address information related to the one or more security inspection execution terminals, wherein
the address management apparatus includes
an obtaining unit configured to obtain the address information related to the one or more security inspection execution terminals, and
a disclosure processing unit configured to disclose, in response to a request from the network node, to the network node, the address information related to the one or more security inspection execution terminals.

### (Supplementary Note 10)

The address management system according to supplementary note 9, wherein
the one or more security inspection execution terminals are configured to notify the network node of identification information for identifying corresponding address information, and
the network node is configured to make the request by using the identification information to thereby obtain address information disclosed by the disclosure processing unit included in the address management apparatus.

### (Supplementary Note 11)

The address management system according to supplementary note 9 or 10, wherein
the address management apparatus further includes
   a monitoring unit configured to monitor connectivity of the address information, and
   an asking unit configured to transmit, based on the connectivity of the address information, information for asking for update of address information to the one or more security inspection execution terminals, and
the one or more security inspection execution terminals are configured to transmit, based on the information for asking the update, information for requesting update of address information to the address management apparatus.

### (Supplementary Note 12)

The address management system according to supplementary note 11, wherein the obtaining unit of the address management apparatus is configured to update, according to the information for requesting the update, address information related to a corresponding security inspection execution terminal among the one or more security inspection execution terminals.

### (Supplementary Note 13)

An address management method comprising:
obtaining address information related to one or more security inspection execution terminals accessing a security inspection target system for security inspection; and
disclosing, in response to a request from a network node managing the security inspection target system, to the network node, address information related to the one or more security inspection execution terminals.
   (Supplementary note 14)

The address management method according to supplementary note 13, further comprising:
monitoring connectivity of the address information; and
transmitting, based on the connectivity of the address information, information for asking for update of address information, to the one or more security inspection execution terminals.

### (Supplementary Note 15)

A program causing a computer to execute:
obtaining address information related to one or more security inspection execution terminals accessing a security inspection target system for security inspection; and
disclosing, in response to a request from a network node managing the security inspection target system, to the network node, address information related to the one or more security inspection execution terminals.

### INDUSTRIAL APPLICABILITY

It is possible to appropriately ensure authenticity of a security inspection execution terminal and provide an environment for executing security inspection, even when address information of the security inspection execution terminal is changed.

### REFERENCE SIGNS LIST

1 Address Management System
2 Internet
20 Security Inspection Target System
21 Network Node
22 Security Apparatus
30, 30a, 30b, 30c Security Inspection Execution Terminal 30
100 Address Management Apparatus
131, 151 Obtaining Unit
133, 153 Disclosure Processing Unit
135 Monitoring Unit
1351 Transmission Processing Unit
1353 Reception Processing Unit
1355 Determination Processing Unit
137 Asking Unit
139 Approval Unit
141 Control Information Transmission Processing Unit

What is claimed is:

1. An address management apparatus comprising:
a memory storing instructions; and
one or more processors configured to execute the instructions to:
obtain address information related to one or more security inspection execution terminals accessing a security inspection target system for security inspection; and
disclose, in response to a request from a network node managing the security inspection target system, to the network node, address information related to the one or more security inspection execution terminals.

2. The address management apparatus according to claim 1, wherein the one or more processors are further configured to execute the instructions to:
monitor connectivity of the address information; and
transmit, based on the connectivity of the address information, information for asking the one or more security inspection execution terminals to update address information.

3. The address management apparatus according to claim 2, wherein the one or more processors are configured to execute the instructions to:
transmit an echo request message for monitoring the connectivity of the address information, to a corresponding security inspection execution terminal among the one or more security inspection execution terminals,
receive an echo response message for the echo request message, from the corresponding security inspection execution terminal, and
determine, based on a reception state related to the echo request message, whether the connectivity of the address information related to the corresponding security inspection execution terminal is enabled or disabled.

4. The address management apparatus according to claim 3, wherein the one or more processors are configured to execute the instructions to configure, based on update history of the address information related to the corresponding security inspection execution terminal, a frequency of transmission of the echo request message to the corresponding security inspection execution terminal.

5. The address management apparatus according to claim 3, wherein the one or more processors are configured to execute the instructions to transmit, when the connectivity of the address information related to the corresponding security inspection execution terminal is disabled, information for asking for update of address information, to the corresponding security inspection execution terminal.

6. The address management apparatus according to claim 2, wherein the one or more processors are configured to execute the instructions to:
monitor image information related to security inspection performed by the one or more security inspection execution terminals, and
disclose, in response to the request from the network node, the image information related to the security inspection to the network node.

7. The address management apparatus according to claim 1, the one or more processors are further configured to execute the instructions to:
approve, based on notification information from the network node, access for the security inspection by a corresponding security inspection execution terminal among the one or more security inspection execution terminals.

8. The address management apparatus according to claim 7, the one or more processors are further configured to execute the instructions to:
transmit control information for the access for the security inspection by the corresponding security inspection execution terminal, to a network node controlling access to the security inspection target system.

9. An address management system comprising:
a security inspection target system;
a network node configured to manage the security inspection target system;
one or more security inspection execution terminals configured to access the security inspection target system for security inspection; and
an address management apparatus configured to manage address information related to the one or more security inspection execution terminals, wherein
the address management apparatus includes a memory storing instructions and one or more processors configured to execute the instructions, the one or more processors being configured to:
obtain the address information related to the one or more security inspection execution terminals, and
disclose, in response to a request from the network node, to the network node, the address information related to the one or more security inspection execution terminals.

10. The address management system according to claim 9, wherein
the one or more security inspection execution terminals are configured to notify the network node of identification information for identifying corresponding address information, and
the network node is configured to make the request by using the identification information to thereby obtain address information disclosed by the disclosure processing unit included in the address management apparatus.

11. The address management system according to claim 9, wherein
the one or more processors of the address management apparatus are further configured to execute the instructions to:
monitor connectivity of the address information, and
transmit, based on the connectivity of the address information, information for asking for update of address information to the one or more security inspection execution terminals, and
the one or more security inspection execution terminals are configured to transmit, based on the information for asking the update, information for requesting update of address information to the address management apparatus.

12. The address management system according to claim 11, wherein the one or more processors of the address management apparatus are configured to execute the instructions to update, according to the information for requesting the update, address information related to a corresponding security inspection execution terminal among the one or more security inspection execution terminals.

13. An address management method comprising:
obtaining address information related to one or more security inspection execution terminals accessing a security inspection target system for security inspection; and
disclosing, in response to a request from a network node managing the security inspection target system, to the network node, address information related to the one or more security inspection execution terminals.

14. The address management method according to claim 13, further comprising:
monitoring connectivity of the address information; and
transmitting, based on the connectivity of the address information, information for asking for update of address information, to the one or more security inspection execution terminals.

15. A non-transitory computer readable recording medium storing a program causing a computer to execute:
obtaining address information related to one or more security inspection execution terminals accessing a security inspection target system for security inspection; and
disclosing, in response to a request from a network node managing the security inspection target system, to the network node, address information related to the one or more security inspection execution terminals.
